(19) United States
(12) Patent Application Publication
(10) Pub. No.: US 2009/0105380 A1
(43) Pub. Date: Apr. 23, 2009

(54) UV ABSORBING ADDITIVES SUITABLE FOR THERMOPLASTIC ARTICLES MADE FROM PROCESSES WITH EXTENDED HEAT HISTORIES

(75) Inventors: Ryan Thomas Neill, Kingsport, TN (US); Gary Wayne Hartley, Kingsport, TN (US); Michael Eugene Donelson, Kingsport, TN (US); James Collins Maine, Church Hill, TN (US); Douglas Stephens McWilliams, Kingsport, TN (US); Adia Marie Delaney-Jackson, Jefferson City, TN (US); Deanna Lynn Pickel, Knoxville, TN (US)

Correspondence Address: LOUIS N. MORENO, P.O. BOX 511 , B-75, KINGSPORT, TN, 37662, US

(73) Assignee: EASTMAN CHEMICAL COMPANY, Kingsport, TN (US)

(21) Appl. No.: 11/876,305

(22) Filed: Oct. 22, 2007

(51) Int. Cl. C08K 5/3492; C08L 67/02; C08L 69/00

(52) U.S. Cl. 524/100

(57) ABSTRACT

A UV-protected, laminated article obtained by a thermocompressive lamination process. The laminated article is characterized by reduced haze due to the use of a benzotriazine UV absorber. A process for making such a laminated article and a method for preventing or inhibiting haze from developing in a UV-protected laminated article during application of heat and pressure are also described.

### FIELD OF THE INVENTION

This invention generally relates to UV-protected laminated articles obtained by a thermocompressive lamination process. The laminated articles are characterized by reduced haze due to the use of a benzotriazine UV absorber. The invention also generally relates to a process for making such a laminated article and a method for preventing or inhibiting haze from developing in a UV-protected laminated article during application of heat and pressure.

### BACKGROUND OF THE INVENTION

Protection from damage due to exposure to ultraviolet (UV) radiation is often needed for thermoplastic articles that will be exposed to light sources containing these wavelengths. This protection is often provided during manufacturing either by “bulk-loading” the entire resin with UV stabilizers during the extrusion or molding process or by concentrating the additives on the surface of an article using either a co-extruded layer or laminated film containing the stabilizers.

These UV-stabilized thermoplastics often experience additional heat histories from downstream processing in order to convert them into finished products for different applications. The downstream processing includes processes such as thermocompressive lamination, thermoforming, drape forming, in-line film lamination, fabrication (such as edge or surface polishing), sterilization, and the like. In certain circumstances, these additional heat histories can cause undesirable haze to develop in an otherwise clear part.

The present invention is directed to solving this as well as other problems that will be apparent to those skilled in the art upon reading the remainder of the description and the appended claims.

### SUMMARY OF THE INVENTION

In one aspect, the present invention provides a laminated article obtained by applying heat and pressure to two or more layers. At least one of the layers in the article comprises a benzotriazine UV absorber and a polymer selected from a transparent copolyester and a miscible polyester/polycarbonate blend.

In a second aspect, the invention provides a process for making a laminated article. The process comprises applying heat and pressure to two or more layers, wherein at least one of the layers comprises a benzotriazine UV absorber and a polymer selected from a transparent copolyester and a miscible polyester/polycarbonate blend.

In a third aspect, the invention provides a method for preventing or inhibiting haze from developing in a UV absorber-containing laminated article during application of heat and pressure. The method comprises using 2-[4,6-bis(2,4-dimethylphenyl)-1,3,5-triazin-2-yl]-5-(octyloxy)phenol or 2-(4,6-diphenyl-1,3,5-triazin-2-yl)-5-hexyloxy-phenol as the UV absorber.

### DETAILED DESCRIPTION OF THE INVENTION

We have surprisingly found both the cause and the solution to the problem of haze developing in UV absorber-containing thermoplastic articles that have been subjected to additional heat histories from downstream processing. It has been surprisingly found that certain classes of UV absorbers cause this problem, while others can withstand additional heat histories without forming an undesirable level of haze.

In particular, it has been surprisingly found that UV absorbers that can be used in high loadings and be exposed to extended heat histories while maintaining high clarity include benzotriazines, benzotriazoles, and benzophenones. On the other hand, UV absorbers such as benzoxazinones cannot.

The preferred class of UV absorbers is benzotriazines. Examples of compounds falling within this class include 2-[4,6-bis(2,4-dimethylphenyl)-1,3,5-triazin-2-yl]-5-(octyloxy)phenol (CAS No. 2725-22-6; commercially available as Cyasorb® UV-1164 from Cytec Industries Inc.) and 2-(4,6-diphenyl-1,3,5-triazin-2-yl)-5-hexyloxy-phenol (CAS No. 147315-50-2; commercially available as Tinuvin® 1577 from Ciba Specialty Chemicals Inc.).

The amount of UV absorber used can vary depending on the application. Typically, the UV absorber concentration can range from about 1 to 20 wt %, 1.8 to 12 wt %, or 2.6 to 9 wt %, based on the weight of the layer in which it is incorporated.

Thus, in one aspect, the present invention provides a laminated article obtained by applying heat and pressure to two or more layers. At least one of the layers in the article comprises a benzotriazine UV absorber and a polymer selected from a transparent copolyester and a miscible polyester/polycarbonate blend.

The layer containing the UV absorber (UVA) may be transparent or translucent, while the remaining layer(s) may be transparent, translucent, or opaque, depending on the particular aesthetic effect desired. The different layers may differ in degree of transparency or translucency and also in color.

The process of making a laminate using heat and pressure is commonly known as thermocompressive lamination. A typical thermocompressive lamination procedure involves placing a “book” of items to be laminated in a heated press with platen temperatures of about 120° C. and a pressure of about 75 pounds per square inch for a cycle time of about 2 to 90 minutes, where the temperature and pressure depend on the characteristics of the encapsulant or inclusion (if any), and the length of the cycle time depends on the thickness of the article being laminated and the total number of items being laminated when stacked together in one press opening. A typical layup for the book would include the following layered arrangement (from the bottom, upward): a metallic transfer plate; a pressure distribution pad (rubber silicone, paper corrugation, thermally-stable fabric, etc.); a thin, optionally polished, metallic plate; an optional release film or paper; a thin, clear, extruded copolyester film containing a UV additive with a matte texture oriented upward (matte texture toward the sheet to be described next) to prevent air entrapment; a copolyester plastic sheeting with matte surface upward; a decorative or functional layer to be encapsulated; and repeating the layers in reverse to complete the layup to make one laminated structure. Note that a book can be constructed such that several laminates are manufactured in one press opening. Also note that variations to the above example are possible.

The laminates of the invention can include one or more items adhered to the surface of one layer, or encapsulated between two or more layers, of a thermoplastic film or sheet. The adhered or encapsulated item includes, but is not limited to, fabric; metallic wire, rod, or bar; stone; paper; colored film; decorative film; light modifying film; printed images; vegetation; wood; wood chips; bamboo; pine straw; moss; lichen; grasses; thatch; flowers; flower petals; wheat; grains; beads; pellets; glass; crushed glass; pebbles; and the like. The item also includes an electrically energized device comprising light emitting capacitors (LECs), light emitting diodes (LEDs), and printed “circuit boards”; paper that emit light when energized; electrochromic layers; photovoltaics; transmitters; receivers; antennas; electromagnets; electrodes; and smart sensors capable of detecting wind speed and direction, temperature, pressure, relative humidity, rainfall, motion, radiation, or a specific chemical species. The item can be combinations of any of the foregoing.

The laminates of the invention can be used as decorative or functional articles. Such articles include, but are not limited to, counter tops, table tops, cabinet doors, game boards, toys, panels for shower stalls, hot tubs, marker boards, indoor and outdoor signs, vanity tops including sink, soap dish, back splash, flooring, billboard signage, backlit bus advertisement, street furniture, bus shelters, POP (point-of-purchase) displays, flooring, kiosks, smart sensors, decorative walls, partitions, glazing applications, and the like.

The laminates of the invention can include a decorative texture or design on a surface thereof, such as those described in U.S. Pat. No. 6,025,069; the entire content of which is hereby incorporated by reference.

The term “polyester,” as used herein, is intended to include “copolyesters” and is understood to mean a synthetic polymer prepared by the reaction of one or more difunctional carboxylic acids with one or more difunctional hydroxyl compounds. Typically, the difunctional carboxylic acid can be a dicarboxylic acid and the difunctional hydroxyl compound can be a dihydric alcohol such as, for example, glycols and diols. Alternatively, the difunctional carboxylic acid may be a hydroxycarboxylic acid such as, for example, p-hydroxybenzoic acid, and the difunctional hydroxyl compound may be an aromatic nucleus bearing 2 hydroxyl substituents such as, for example, hydroquinone. The term “residue,” as used herein, means any organic structure incorporated into a polymer through a polycondensation and/or an esterification reaction from the corresponding monomer. The term “repeating unit,” as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, the term “dicarboxylic acid” is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester.

Suitable transparent copolyesters for use in the invention include copolyesters commercially available from Eastman Chemical Company such as PETG Spectar™ Copolyester. These copolyesters comprise repeating units of diacid residues and diol residues. At least 80 mole percent of the diacid residues are terephthalic acid residues. The diacid component of the copolyesters optionally may comprise up to 20 mole percent of one or more other dicarboxylic acid such that the sum of the dicarboxylic acid units is equal to 100 mol percent. Examples of such other dicarboxylic acids include phthalic acid; isophthalic acid; 1,4-, 1,5-, 2,6-, or 2,7-naphthalenedicarboxylic acid; 1,3- or 1,4-cyclohexanedicarboxylic acid (which may be cis, trans or a mixture thereof); cyclohexanediacetic acid; trans-4,4′-stilbenedicarboxylic acid; 4,4′-oxydibenzoic acid; 3,3′- and 4,4′-bi-phenyidicarboxylic acids; and aliphatic dicarboxylic acids such as malonic, succinic, glutaric, adipic, pimelic, suberic, azelaic, sebacic, nonane, decane, and dodecanedicarboxylic acids. The diacid residues may be derived from the dicarboxylic acid; the dialkyl esters thereof, e.g., dimethyl terephthalate and bis(2-hydroxyethyl) terephthalate; the acid chlorides thereof; and, in some cases, the anhydrides thereof.

In one embodiment, the diol component of the copolyesters comprises from 98 to 1 mole percent ethylene glycol residues and from 2 to 99 mol percent of 1,3-cyclohexanedimethanol and/or 1,4-cyclohexanedimethanol residues. Up to 20 mole percent of the diol component may be made up of the residues of one or more diols other than ethylene glycol and cyclohexanedimethanol such that the sum of all diol residues is 100 mole percent. Examples of such additional diols include cycloaliphatic diols having 3 to 16 carbon atoms and aliphatic diols having 3 to 12 carbon atoms. Specific examples of such other diols include, but are not limited to, 1,2-propanediol; 1,3-propanediol; neopentyl glycol; 2-methyl-1,3-propanediol; 1,4-butanediol; 1,5-pentanediol; 1,6-hexanediol; 2,2,4,4-tetramethyl-1,3-cyclobutanediol (trans-, cis- or mixtures thereof); and p-xylylene glycol. The copolyesters also may be modified with minor amounts of polyethylene glycols or polytetramethylene glycols, e.g., polyethylene glycols and polytetramethylene glycols having weight average molecular weights in the range of about 500 to 2000, to enhance elastomeric behavior.

In another embodiment of the present invention, the diol component of the copolyesters contains residues of ethylene glycol and 1,4-cyclohexanedimethanol, wherein the mole ratio of ethylene glycol residues:1,4-cyclohexanedimethanol residues is about 5:95 to about 95:5, or preferably about 30:70 to about 88:12, or more preferably about 50:50 to about 77:23.

In another embodiment, the diol portion of the copolyesters comprises residues of neopentyl glycol and 1,4- or 1,3-cyclohexanedimethanol (cis-, trans-, or mixtures thereof). In another embodiment, the diol portion of the copolyesters comprises residues of ethylene glycol and 2-methyl-1,3-propanediol. In another embodiment, the diol portion of the copolyesters comprises residues of ethylene glycol and neopentyl glycol. In another embodiment, the diol portion of the copolyesters comprises residues of 1,3- or 1,4-cyclohexanedimenthanol (cis-, trans-, or mixtures thereof) and 2-methyl-1,3-propandediol. In another embodiment, the diol portion of the copolyesters comprises residues of neopentyl glycol and 2-methyl-1,3-propandediol. The mole ratios of these mixtures of diols can be the same as those for EG and CHDM.

The copolyesters can have an inherent viscosity in the range of 0.5 to 1.2 dL/g when measured at 25° C. using 0.50 grams of polymer per 100 ml of a solvent which consists of 60% by weight phenol and 40% by weight tetrachloroethane. The copolyesters utilized in the laminated articles of the present invention preferably have an inherent viscosity of 0.6 to 0.9 dL/g.

The copolyesters useful in the present invention may be prepared by conventional polycondensation procedures well-known in the art. Such processes include direct condensation of the dicarboxylic acid(s) with the diols or by ester interchange using a dialkyl or diaryl dicarboxylate. For example, a dialkyl terephthalate, e.g., dimethyl terephthalate or bis(2-hydroxyethyl) terephthalate, or a diaryl ester such as diphenyl terephthalate is ester interchanged with the diols at elevated temperatures in the presence of a polycondensation catalyst.

Typical catalysts or catalyst systems for polyester condensation are well known in the art. Suitable catalysts are disclosed, for example, in U.S. Pat. Nos. 4,025,492, 4,136,089, 4,176,224, 4,238,593, and 4,208,527, the disclosures of which are herein incorporated by reference. Further, R. E. Wilfong, Journal of Polymer Science, 54, 385, (1961) describes typical catalysts, which are useful in polyester condensation reactions. Preferred catalyst systems include Ti, Ti/P, Mn/Ti/Co/P, Mn/Ti/P, Zn/Ti/Co/P, Zn/Al, and Li/Al. When cobalt is not used in the polycondensation, copolymerizable toners may be incorporated into the copolyesters to control the color of these copolyesters so that they are suitable for applications in which color may be a desirable property. In addition to the catalysts and toners, other conventional additives, such as antioxidants, dyes, etc., may be used in the copolyesterifications in typical amounts.

Miscible polyester/polycarbonate blends suitable for use in the present invention include those comprising:
(a) 1 to 99 weight % of a polyester, comprising:
   (i) a diacid component comprising the residues of aliphatic, alicyclic, and/or aromatic dicarboxylic acids, wherein the aromatic portion of said aromatic dicarboxylic acid has 6-20 carbon atoms and wherein the aliphatic or alicyclic portion of said aliphatic or alicyclic dicarboxylic acid has 3-20 carbon atoms; and
   (ii) a diol component comprising from 40 mole % to 100 mole % of 1,4-cyclohexanedimethanol residues and, optionally, the residues of at least one additional aliphatic glycol having 2-20 carbon atoms;
wherein the total mole percentages for the diol component equals 100 mole %; and
(b) 1 to 99 weight % of a polycarbonate,
   wherein the total combined weight percentage of polyester and polycarbonate in the polyester/polycarbonate blend equals 100 weight %. Such blends are described in U.S. Pat. No. 6,896,966; the entire content of which is hereby incorporated by reference.

In one embodiment, the polyester/polycarbonate blend comprises 50-90 wt % of the polyester and 10-50 wt % of the polycarbonate. In another embodiment, the blend comprises 60-80 wt % of the polyester and 20-40 wt % of the polycarbonate.

Polyesters particularly suitable for use in the polyester/polycarbonate blends include those having repeating unit of the Formula III:

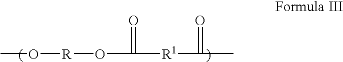

wherein R is the residue of 1,4 cyclohexanedimethanol or a mixture of 1,4-cyclohexanedimethanol and at least one aryl, alkane, or cycloalkane containing diol having 2 to 20 carbon atoms; and wherein R¹ is the decarboxylated residue derived from an aryl, aliphatic, or cycloalkane containing diacid of 3 to 20 carbon atoms.

Examples of diols having 2 to 20 carbon atoms in the diol portion, R, include ethylene glycol, 1,2-propylene glycol, 1,3-propanediol, 1,4-butanediol, 1,5-pentanediol, 1,6-hexanediol, 1,2- or 1,3-cyclohexanedimethanol, neopentyl glycol, and 2,2,4,4 tetramethyl-1,3-cyclobutanediol. In one embodiment, R is the residue of a mixture of 1,4-cyclohexanedimethanol and ethylene glycol.

Examples of diacids in the diacid portion, R¹, include malonic, succinic, glutaric, adipic, pimelic, suberic, azelaic, sebacic, dodecanedioic, 1,4-, 1,5-, and 2,6-decahydronaphthalenedicarboxylic acid, and cis- or trans-1,4-cyclohexanedicarboxylic acid. Examples of useful aromatic dicarboxylic acids include terephthalic acid; isophthalic acid; 4,4′-biphenyidicarboxylic; trans 3,3′- or trans 4,4′-stilbenedicarboxylic acid; 4,4′-dibenzyldicarboxylic acid; and 1,4-, 1,5-, 2,3-, 2,6-, or 2,7-naphthalenedicarboxylic acid. Chemical equivalents of these diacids include esters, alkyl esters, dialkyl esters, diaryl esters, anhydrides, salts, acid chlorides, acid bromides, and the like are included within the scope of this invention. In certain embodiments, the preferred dicarboxylic acids are terephthalic or isophthalic acid or mixtures thereof. In certain embodiments, the preferred chemical equivalent is dialkyl esters of terephthalic or isophthalic acid. Mixtures of any of these acids or equivalents may be used.

In one embodiment of the polyester/polycarbonate blends, the polyester has from 40 to 100 mole %, more preferably 60 to 80 mole %, of 1,4-cyclohexanedimethanol residues, based on the total mole percentage of the glycol component in the polyester. The remainder of the glycol component can include any of the other glycols described herein but, in certain embodiments, preferably comprises ethylene glycol residues in the amount of 0 to 60 mole %, more preferably, 20 to 40 mole %. Although any diacid as described herein may be used, 80 to 100 mole % of terephthalic acid residues are preferred.

In another embodiment of the polyester/polycarbonate blends, the polyester has 100 mole % of 1,4-cyclohexanedimethanol residues, based on the total mole percentage of the glycol component in the polyester. Also, in this particular embodiment, it is preferred that isophthalic acid residues are present in the amount of 5 to 50 mole %, more preferably, 20 to 40 mole %. Although any diacid as described herein may be used, it is preferred that terephthalic acid residues are present in the amount of 95 to 50 mole %.

Conventional polycondensation processes can be used to prepare the polyesters useful in the present invention. These include direct condensation of the acid(s) with the diol(s) or by ester interchange using lower alkyl esters.

The inherent viscosity of the polyesters in the polyester/polycarbonate blends may range from about 0.4 to about 1.0 dl/g at 25° C., measured by dissolving 0.50 g of the polyester in 100 mL of a solvent consisting of 60% by weight phenol and 40% by weight tetrachloroethane.

In certain embodiments, one or more branching agents may be useful in making the copolyester or the polyester in the polyester/polycarbonate blends in the present invention. The branching agent can be one that provides branching in the acid unit portion of the polyester, or in the glycol unit portion, or it can be a hybrid. Illustrative of such branching agents are polyfunctional acids, polyfunctional alcohols, acid/alcohol hybrids, and reactive epoxides. Examples of branching agents include, but are not limited to, trimesic acid, trimellitic acid, pyromellitic acid, citric acid, tartaric acid, trimellitic anhydride, pyromellitic dianhydride, trimethylolpropane, glycerol, pentaerythritol, 3-hydroxyglutaric acid, dendritic polymers, glycidyl methacrylate, and mixtures thereof. Trimellitic anhydride is a preferred branching agent. The branching agent may be present in amounts ranging from about 0.05 to about 0.75 wt %, about 0.05 to about 0.5 wt %, or about 0.05 to about 0.25 wt %, based on the weight of the copolyester or the polyester in the polyester/polycarbonate blend.

Polycarbonates useful in the polyester/polycarbonate blends of this invention comprise the divalent residue of dihydric phenols bonded through a carbonate linkage and are represented by structural formulae I and II:

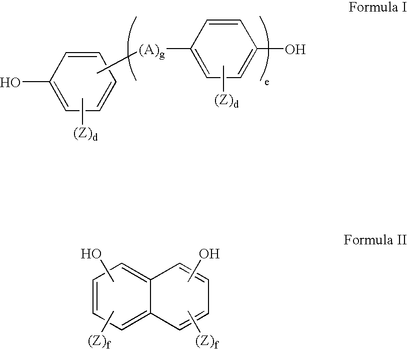

wherein:

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom,

—SO— or —SO₂; or a radical conforming to e and g where both denote the number 0 to 1;

Z denotes F, Cl, Br, or C₁₋₄ alkyl; and if several Z radicals are substituents in one aryl radical, they may be identical or different from one another;

d denotes an integer of from 0 to 4; and

f denotes an integer of from 0 to 3.

By the term “alkylene” is meant a bivalent saturated aliphatic radical wherein the two valences are on different carbon atoms, e.g., ethylene, 1,3-propylene, 1,2-propylene, 1,4-butylene, 1,3-butylene, 1,2-butylene, amylene, and isoamylene, etc.

By the term “alkylidene” is meant a bivalent radical wherein the two valences are on the same carbon atoms, e.g., ethylidene, propylidene, isopropylidine, butylidene, isobutylidene, amylidene, isoamylidene, and 3,5,5,-trimethylhexylidene.

Examples of “cycloalkylene” include cyclopropylene, cyclobutylene, and cyclohexylene.

Examples of “cycloalkylidene” include cyclopropylidene, cyclobutylidene, and cyclohexylidene.

Examples of C₁₋₄ alkyl include methyl, ethyl, propyl, isopropyl, butyl, and isobutyl.

Typical of some of the dihydric phenols employed are bis-phenols such as 2,2-bis-(4-hydroxyphenyl)-propane (bisphenol A); 3,3,5-trimethyl-1,1-bis(4-hydroxyphenyl)-cyclohexane; 2,4-bis-(4-hydroxyphenyl)-2-methyl-butane; 1,1-bis-(4-hydroxyphenyl)-cyclohexane; α,α′-bis-(4-hydroxyphenyl)-p-diisopropylbenzene; 2,2-bis-(3-methyl-4-hydroxyphenyl)-propane; 2,2-bis-(3-chloro-4-hydroxyphenyl)propane; bis-(3,5-dimethyl-4-hydroxyphenyl)-methane; 2,2-bis-(3,5-dimethyl-4-hydroxyphenyl)-propane; bis-(3,5-dimethyl-4-hydroxyphenyl)-sulfide; bis-(3,5dimethyl-4-hydroxyphenyl)-sulfoxide; bis-(3,5-dimethyl-4-hydroxyphenyl)-sulfone; dihydroxy-benzophenone; 2,4-bis-(3,5-dimethyl-4-hydroxyphenyl)-cyclohexane; α,α′-bis-(3,5-dimethyl-4-hydroxyphenyl)-p-diisopropylbenzene; and 4,4′-sulfonyl diphenol. Other dihydric phenols might include hydroquinone, resorcinol, bis-(hydroxyphenyl)-alkanes, bis-(hydroxyphenyl)ethers, bis-(hydroxyphenyl)-ketones, bis-(hydroxyphenyl)-sulfoxides, bis-(hydroxyphenyl)-sulfides, bis-(hydroxyphenyl)-sulfones, and α,α-bis-(hydroxyphenyl)diisopropylbenzenes, as well as their nuclear-alkylated compounds. These and further suitable dihydric phenols are described, for example, in U.S. Pat. Nos. 2,991,273; 2,999,835; 2,999,846; 3,028,365; 3,148,172; 3,153,008; 3,271,367; 4,982,014; and 5,010,162; all incorporated herein by reference. The polycarbonates of the invention may entail in their structure, units derived from one or more of the suitable bisphenols. The most preferred dihydric phenol is 2,2-bis-(4-hydroxyphenyl)-propane (bisphenol A).

The carbonate precursors are typically a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxyphenyl)-propane, hydroquinone, and the like, or bishaloformates of glycol, and the like. While all of the above carbonate precursors are useful, carbonyl chloride, also known as phosgene, and diphenyl carbonate are preferred.

The aromatic polycarbonates can be manufactured by any known process such as by reacting a dihydric phenol with a carbonate precursor, such as phosgene, a haloformate or carbonate ester in melt or solution. Suitable processes are disclosed in U.S. Pat. Nos. 2,991,273; 2,999,846; 3,028,365; 3,153,008; and 4,123,436; all of which are incorporated herein by reference.

In certain embodiments of the present invention, the polycarbonates can have a weight average molecular weight, as determined by gel permeation chromatography, of about 10,000 to 200,000, preferably 15,000 to 80,000, and their melt flow index, per ASTM D-1238 at 300° C., can be about 1 to 65 g/10 min, preferably about 2 to 30 g/10 min. The polycarbonates may be branched or unbranched. It is contemplated that the polycarbonate may have various known end groups. These resins are known and are readily available in commerce.

One or more branching agents may be used in making the polycarbonates of the invention. Branching agents, such as tri- and tetra-functional phenols and carbonic acids, as well as bisphenols with carbonic acid side chains can be used. Examples include 1,4-bis(4′,4″-dihydroxytriphenylmethyl)benzene and trisphenol TC. Nitrogen-containing branching agents can also be used. Examples include cyanic chloride and 3,3-bis(4-hydroxyphenyl)-2-oxo-2,3-dihydroindole.

Polymer miscibility is defined herein as a polymer blend or mixture forming a single phase.

Miscible polymer blends useful in this invention were first disclosed in Research Disclosure 22921, May, 1983, which concerns blends of polycarbonate with polyesters based on terephthalic acid and a mixture of 1,4-cyclohexanedimethanol and ethylene glycol. Similar miscible blends are disclosed in U.S. Pat. Nos. 4,786,692 and 5,478,896. Blends of polycarbonate with another family of polyesters, those based on a mixture of terephthalic and isophthalic acids with 1,4-cyclohexanedimethanol, are disclosed in U.S. Pat. Nos. 4,188,314 and 4,391,954. British Patent Specification 1,599,230 (published Jan. 16, 1980) discloses blends of polycarbonate with polyesters of 1,4-cyclohexanedimethanol and a hexacarbocyclic dicarboxylic acid. Mohn et al. reported on thermal properties of blends of polyesters based on 1,4-cyclohexanedimethanol and terephthalic acid or terephthalic/isophthalic acid mixtures with polycarbonate [J. AppI. Polym. Sci., 23, 575 (1979)].

The polyester/polycarbonate blends useful in this invention may be made by conventional melt processing techniques. For example, pellets of the polyester may be mixed with pellets of the polycarbonate and subsequently melt blended on either a single or twin screw extruder to form a homogenous mixture.

The copolyesters and polyester/polycarbonate blends useful in various embodiments of the invention may contain impact modifiers, stabilizers (including phosphorous-based stabilizers for color reduction), nucleating agents, extenders, flame retarding agents, reinforcing agents, fillers, antistatic agents, antimicrobial agents, antifungal agents, self-cleaning or low surface energy agents, mold release agents, scents, colorants, antioxidants, extrusion aids, slip agents, release agents, carbon black, other pigments, and mixtures thereof.

In a second aspect, the invention provides a process for making a laminated article. The process comprises applying heat and pressure to two or more layers, wherein at least one of the layers comprises a benzotriazine UV absorber and a polymer selected from a transparent copolyester and a miscible polyester/polycarbonate blend, as described herein.

The process according to the invention can be applied to make laminated articles having two or more layers. The number of layers is not particularly limiting. However, for ease of discussion, a process for making a two-layer structure is described below.

The laminated article can be made from sheet material. The upper and lower sheet materials used in the manufacture of the laminated article may be the same or different. For example, one of the sheet materials may be produced from a virgin polyester and the other may be produced from a recycled copolyester. The thickness of the sheet materials used in the preparation of the laminated article can vary, depending upon a number of factors such as functionality, weight, cost, and the like. The sheet material from which the upper layer is formed generally has a thickness in the range of about 0.015-0.500 inch, preferably in the range of about 0.050-0.250 inch. The sheet material from which the lower layer is formed typically has a thickness in the range of 0.015-0.500 inch, preferably in the range of about 0.050-0.250 inch.

The laminated article of the present invention may be produced by subjecting the layers to temperatures and pressures sufficient to cause the upper and lower sheet material to bond or fuse together. In case an inclusion is provided between the layers, sufficient heat and pressure is applied to cause the upper and lower sheet material to bond or fuse around the object to be encapsulated. Although the upper and lower sheet may also bond to the object to be encapsulated, this is not required. However, temperatures that cause decomposition, distortion, or other undesirable effects in the encapsulant should be avoided. Typically, the bonding temperatures are in the range of about 80 to 220° C. (176 to 425° F.), preferably in the range of about 82 to 200° C. (180 to 392° F.). For certain embodiments of the invention, the temperature has a lower limit of 80, 90, 100, 110, 120, 130, 140, 150, 160, 170, 180, 190, 200, 210, or 220° C. The temperature has an upper limit of 220, 210, 200, 190, 180, 170, 160, 150, 140, 130, 120, 110, 100, or 90° C. For various embodiments of the invention, the range of temperature may be any combination of the lower limit of temperature with any upper limit of temperature. The pressures utilized in the bonding or laminating of the thermoplastic article of the invention preferably are in the range of about 0.034 to 2.41 MPa (about 5 to 350 pounds per square inch gauge (“psig”)). For certain embodiments of the invention, the pressure has a lower limit of 5, 10, 20, 30, 40, 50, 60, 70, 80, 90, 100, 110, 120, 130, 140, 150, 175, 200, 225, 250, 275, 300 or 325 psig. For certain embodiments of the invention, the pressure has an upper limit of 10, 20, 30, 40, 50, 60, 70, 80, 90, 100, 110, 120, 130, 140, 150, 175, 200, 225, 250, 275, 300, 325 or 350 psig. For various embodiments of the invention, the range of pressure may be any combination of the lower limit of pressure with any upper limit of pressure.

The temperature for bonding the laminated articles will vary depending, for example, on the particular material or blend employed and the thickness of the sheet materials used, and may be determined by those skilled in the art using the disclosure herein. The pressure will vary depending on the pressure sensitivity of the object being encapsulated. Light emitting capacitor (LEC) panels, as an example, can be pressed at approximately 0.10 MPa (15 psig). The laminate is held at the appropriate temperature and pressure for about 5 to 45 minutes, or until such time as a bond is formed between the upper and lower sheet materials. After 5 to 45 minutes, the bonded/fused thermoplastic article is allowed to cool under pressures from about 0.034 to 2.41 MPa (about 5 to 350 psig), preferably about 0.10 MPa (15 psig), until it cools below the glass transition temperature of the sheet material. In certain embodiments of the present invention, during the bonding process, the sheet material may be bonded or fused to the object to be encapsulated without the use of an adhesive.

The residence times of 5 to 45 minutes are generally applicable to single laminates layup configurations. Multiple laminate layups, stacked vertically and separated by release papers and caul plates, can also be constructed such that multiple laminates are produced in just one heated platen opening. The residence times for these multiple layup configurations may exceed 45 minutes. Proper residence times for multiple layup configurations may be determined by one of ordinary skill using the disclosure herein. The lower limit of the residence time for the single laminate layup may be 5, 10, 15, 20, 25, 30, or 40 minutes. The upper limit of the residence time for the single laminate layup may be 45, 40, 35, 30, 25, 20, 15, or 10 minutes. For various embodiments of the invention, the range of residence times may be any combination of the lower limit of residence time with any upper limit of residence time.

One aspect of the current invention involves using relatively low forces during the thermocompressive lamination procedure to make pressure-sensitive electrical structures. The use of low forces, however, may cause air entrapment. Typical air removal methods include lamination under a vacuum; pre-drying the raw materials; or creating channels for air escape, such as a matte texture on the sheet surface, matte textured release paper, or including a “glass sheen” PET fabric (available from Danzian) between areas prone to air entrapment. For thicker panels (about 10 mils or thicker), polymeric thin film shims can be added around the article to be encapsulated to further aid air removal. When using matte sheet, place the matte side facing the encapsulated item. The target “Ra” or surface roughness measurement should be about 90 micro inches, where the preferred surface roughness value depends on the type of inclusion being encapsulated.

For temperature-sensitive objects, additional insulating layers can be added to further protect the sensitive portions of the panel. The insulating layers may be an interior layer that becomes a part of the finished laminated panel or the insulating layers may be external layers that are removed when the laminated panel is removed from the lamination press.

As noted above, the upper and lower sheet materials used in the manufacture of the laminated articles of the present invention may be the same or different. For example, the upper and lower sheet materials may be produced from different copolyesters or polyester/polycarbonate blends or compositions that contain different additives. When the upper and lower sheet materials are produced from chemically dissimilar materials, the dissimilar materials should be thermally compatible. As used herein, the term “thermal compatibility” means that when layers of the sheet materials are bonded together under conditions of elevated temperature and pressure, the layers undergo approximately equal thermal expansion or contraction such that the solid surface is substantially planar. Examples of dissimilar materials compatible with the lamination process include poly(vinyl chloride), poly(ethylene terephthalate), poly(methyl methacrylate), polycarbonate, and the like.

Some encapsulants may have a sensitivity to moisture when exposed to outdoor environments. In addition to pre-drying the raw materials, the encapsulation of additional moisture barriers, such as a layer of EVOH or nanoclay-impregnated metaxylene diamine (“MXD6”), may be desirable beyond the copolyester or polyester/polycarbonate sheeting already present. These barrier layers can be added to the laminate layup as either a film or co-extruded directly onto the plastic sheeting. Desiccants or other hydrophilic moisture scavengers can also be encapsulated with the panels.

The compositions and blends constituting the sheet materials used in the manufacture of the articles of the present invention may not be as hard or scratch resistant as may be necessary or desired for certain end uses. For example, an end use in which the exterior surface of the thermoplastic article may be subjected to scratching or abrasion, e.g., in a wall decoration, may require the application of an abrasion-resistant coating to the exterior surface. In which case, films made of fluorinated hydrocarbons, poly(perfluoroethylene) such as TEDLAR from DuPont or oriented poly(ethylene terephthalate) such as MYLAR from DuPont may be used to improve both chemical and abrasion resistance. The abrasion resistant film typically has a thickness in the range of about 0.025 to 0.254 mm (0.001-0.01 inch), preferably about 0.051 to 0.178 mm (0.002-0.007 inch), and most preferably about 0.076 mm (0.003 inch). However, an abrasion resistant film thinner or thicker than these ranges may be used since the thickness of such film is limited only by the equipment available cost and functionality considerations. An adhesive optionally may be used between the thermoplastic sheet and the abrasion-resistant film.

Alternatively, an abrasion-resistant coating may be applied to a plastic film and then the film bearing the abrasion-resistant coating may be laminated to one or both sides of the article of the present invention. The film may be selected from a number of thermoplastic materials compatible with the lamination process such as poly(vinyl chloride), PETG copolyester, poly(ethylene terephthalate), poly(methyl methacrylate), polycarbonate, polyester/polycarbonate blends, and the like.

The film thickness may range from 0.0025-0.381 mm (0.001-0.015 inch) with a thickness of 0.0762-0.203 mm (0.003-0.008) being most preferred. The coating may be selected from a number of commercially-available materials such as polyurethanes, fluorinated polyurethanes, and silicones which are cured by heat, or they may be selected from materials that are cured by ultraviolet (UV) or electron beam (EB) radiation. Such UV/EB cured materials fall under the general class of acrylates and modified acrylates that contain fluorine, silicone, epoxy, polyester, polyether, or caprolactone residues or functional groups. The particular coating material selected will depend primarily on the degree of abrasion resistance required. Application of the liquid, heat, or UV/EB-curable precursor of the abrasion resistant coating may be carried out according to conventional procedures and usually is accomplished on a roll coating machine. The thickness of the coating applied to a film generally is 0.0076-0.051 mm (0.0003-0.002 inch) with thickness of about 0.0127 mm (0.0005 inch) being most preferred. Primers or tie layers can also be used between the hardcoat and film layer to promote adhesion.

These coatings may be applied in a manner similar to the application of paints. The coatings exist either as predominantly undiluted material with very little volatile content or as solvent- or water-based materials. In addition to being applied to a film that can be laminated to the structure as part of the process, they may be applied directly to the finished product. Application may be carried out by a variety of techniques such as roll, paint, spray, mist, dip, and the like.

The thermoplastic laminate according to the invention can be subsequently shaped or thermoformed into a variety of useful products. As an illustrative example, the laminate can be thermoformed or otherwise shaped into curved signage, shower doors, privacy partitions, and tabletops and other furniture pieces. Depending on the nature of the electrically energized device, the thermoplastic articles of this invention may be formed, heat draped, or molded. In addition, the articles of the present invention can have an appealing appearance with low density to facilitate transport and installation of building materials produced therefrom.

In a third aspect, the invention provides a method for preventing or inhibiting haze from developing in a UV absorber-containing laminated article during application of heat and pressure. The method comprises using 2-[4,6-bis(2,4-dimethylphenyl)-1,3,5-triazin-2-yl]-5-(octyloxy)phenol or 2-(4,6-diphenyl-1,3,5-triazin-2-yl)-5-hexyloxy-phenol as the UV absorber. The preferred UV absorber is 2-[4,6-bis(2,4-dimethylphenyl)-1,3,5-triazin-2-yl]-5-(octyloxy)phenol.

This invention can be further illustrated by the following examples of preferred embodiments thereof, although it will be understood that these examples are included merely for purposes of illustration and are not intended to limit the scope of the invention. Also, all percentages are by weight unless otherwise indicated.

### EXAMPLES

### Example 1

Three-mil thick films of Eastman Chemical Company's Spectar™ copolyester and Cyasorb 3638 (a benzoxazinone) were blended together to obtain UV stabilizer concentrations of 1.8, 2.6, 4.3 and 6.0 wt %.

Similar films were made with blends of Spectar™ copolyester and Cyasorb 1164 (a benzotriazine) at the same loading levels.

The films were made on a 1.5-inch vented Killion extrusion line with a L/D of 30:1. The extrusion conditions included running a straight profile zone temperature of 500° F. at 30 rpm, equating to 16 feet per minute of 12 inch wide film that was 3 mils thick.

These eight film samples, along with an unstabilized Spectar™ film control, were laminated to two 118-mil sheets of Spectar™ on a Carver press at 120° C. platen temperature and 10,000 lb_{f} (about 70 psig) for 10 minutes.

This lamination process was repeated with new film and sheet at 30 and 60 minutes of total lamination time such that a total of 27 plaques of about 0.239-inch thickness were made.

Similarly, the entire process described above was repeated with just the three-mil films (the two 118-mil Spectar™ sheets were omitted) for another 27 samples.

The haze was measured in each sample according to ASTM D1003 Method A, Illuminant C using a BYK Gardner Haze-Gard Plus detector. The standard deviation according to this measurement method is 0.1 to 0.4%. The results are reported in Table 1 below.

TABLE 1

| | Laminated Article | | | | Unlaminated Film | | | |
|---|---|---|---|---|---|---|---|---|
| | % of Haze at | | | | % of Haze at | | | |
| | 0 min. | 10 mins. | 30 mins. | 60 mins. | 0 min. | 10 mins. | 30 mins. | 60 mins. |
| Cyasorb | | | | | | | | |
| 3638 | | | | | | | | |
| 1.8% | n/p | 1.40 | 0.89 | 0.48 | 0.69 | 1.72 | 1.38 | 1.32 |
| 2.6% | n/p | 0.93 | 4.97 | 6.18 | 0.83 | 4.63 | 23.97 | 26.20 |
| 4.3% | n/p | 2.85 | 24.23 | 48.33 | 0.75 | 19.50 | 36.53 | 63.37 |
| 6.0% | n/p | 14.13 | 84.00 | 89.00 | 0.60 | 39.60 | 93.40 | 96.17 |
| Cyasorb | | | | | | | | |
| 1164 | | | | | | | | |
| 1.8% | n/p | 1.43 | 0.37 | 0.97 | 0.68 | 0.97 | 1.16 | 0.82 |
| 2.6% | n/p | 0.88 | 1.19 | 0.51 | 0.75 | 0.58 | 0.83 | 0.59 |
| 4.3% | n/p | 0.61 | 0.66 | 0.98 | 0.70 | 0.61 | 1.09 | 0.88 |
| 6.0% | n/p | 0.41 | 0.68 | 1.52 | 0.66 | 1.31 | 1.05 | 0.92 |
| Control | n/p | 0.98 | 0.95 | 1.07 | 0.70 | 0.92 | 0.88 | 0.72 |
| No UVA | | | | | | | | |

n/p = not possible because lamination adds heat history

Inspection of the films and laminated plaques after heating indicates that a haze level below about 2.3% is needed for an article to remain visually clear. Above this value, the samples begin to show haze in localized areas. For example, the laminate made with 4.3% Cyasorb 3638 that received 10 minutes of heating had a measured haze value of 2.85% and appeared to have a dirty surface that would not clean when rubbed with a cloth. In contrast, Cyasorb 1164 remained clear at every UV stabilizer concentration and heat history that was tested.

Several observations can be made from the data in Table 1. First, the Spectar™ copolyester does not cause haze during the heat treatment.

Second, with respect to Cyasorb 3638, which is a benzoxazinone UVA, for each length of heat treatment time, as the concentration of the UVA goes up, so does the amount of haze. Also, at higher concentrations of the UVA (≧2.6%), as the amount of heat treatment time goes up, so does the amount of haze. These trends exist regardless of whether the article is laminated or not.

Third, the trends associated with Cyasorb 3638 are not seen with Cyasorb 1164, which is a benzotriazine UVA.

Based on the data in Table 1, it can be concluded that Cyasorb 3638 causes hazing during heat treatment, while Cyasorb 1164 does not.

### Example 2

Three-mil thick films of Eastman Chemical Company's Spectar™ copolyester and Tinuvin 234 (a benzotriazole) were blended together to obtain UV stabilizer concentrations of 1.8, 2.6, 4.3 and 6.0 wt %.

Similar films were made with blends of Spectar™ copolyester and Tinuvin 327 (a benzotriazole) at the same loading levels.

Similar films were made with blends of Spectar™ copolyester and Tinuvin P (a benzotriazole) at the same loading levels.

Similar films were made with blends of Spectar™ copolyester and Uvinul 3049 (a benzophenone) at the same loading levels.

These films were made on a 1.5-inch vented Killion extrusion line with a L/D of 30:1. The extrusion conditions included running a straight profile zone temperature of 500° F. at 30 rpm, equating to 16 feet per minute of 12-inch wide film that was 3 mils thick.

These 16 film samples were laminated to two 118-mil sheets of Spectar™ copolyester on a Carver press at 120° C. platen temperature and 10,000 lb_{f} (about 70 psig) for 10 minutes. This process was repeated with new film and sheet at 30 and 60 minutes of total lamination time such that a total of 48 plaques of about 0.239-inch thickness were made.

Similarly, the entire process described above was repeated with just the three-mil films (the two 118-mil Spectar™ sheets were omitted) for another 48 samples.

The haze was measured in each sample according to ASTM D1003 Method A, llluminant C using a BYK Gardner Haze-Gard Plus detector. The results are reported in Table 2 below.

TABLE 2

| | Laminated Article | | | | Unlaminated Film | | | |
|---|---|---|---|---|---|---|---|---|
| | % of Haze at | | | | % of Haze at | | | |
| | 0 min. | 10 mins. | 30 mins. | 60 mins. | 0 min. | 10 mins. | 30 mins. | 60 mins. |
| Tinuvin | | | | | | | | |
| 234 | | | | | | | | |
| 1.8% | n/p | 0.36 | 0.66 | 0.53 | 0.65 | 0.54 | 0.23 | 0.21 |
| 2.6% | n/p | 0.23 | 0.70 | 0.36 | 0.68 | 0.50 | 0.34 | 0.17 |
| 4.3% | n/p | 0.50 | 0.56 | 0.49 | 0.53 | 0.34 | 0.15 | 0.25 |
| 6.0% | n/p | 0.48 | 0.64 | 0.62 | 0.46 | 0.36 | 0.20 | 0.13 |
| Tinuvin | | | | | | | | |
| 327 | | | | | | | | |
| 1.8% | n/p | 0.56 | 0.46 | 0.41 | 0.82 | 0.50 | 0.31 | 0.35 |
| 2.6% | n/p | 0.34 | 0.73 | 0.49 | 0.73 | 0.58 | 0.46 | 0.36 |
| 4.3% | n/p | 0.56 | 0.43 | 0.59 | 0.61 | 0.45 | 0.34 | 0.29 |
| 6.0% | n/p | 0.56 | 0.55 | 0.49 | 0.59 | 0.34 | 0.24 | 0.25 |
| Tinuvin P | | | | | | | | |
| 1.8% | n/p | 0.52 | 0.66 | 0.38 | 0.70 | 0.34 | 0.25 | 0.30 |
| 2.6% | n/p | 0.74 | 0.74 | 0.64 | 0.39 | 0.43 | 0.30 | 0.30 |
| 4.3% | n/p | 1.44 | 1.23 | 0.63 | 0.30 | 0.34 | 0.25 | 0.86 |
| 6.0% | n/p | 0.80 | 0.67 | 0.38 | 0.51 | 0.78 | 0.28 | 0.31 |
| Uvinul | | | | | | | | |
| 3049 | | | | | | | | |
| 1.8% | n/p | 0.67 | 0.65 | 0.62 | 0.79 | 0.70 | 0.68 | 0.70 |
| 2.6% | n/p | 0.55 | 0.49 | 0.59 | 0.68 | 0.59 | 0.60 | 0.58 |
| 4.3% | n/p | 0.37 | 0.34 | 0.36 | 0.48 | 0.39 | 0.41 | 0.38 |
| 6.0% | n/p | 0.29 | 0.26 | 0.26 | 0.40 | 0.33 | 0.31 | 0.26 |

n/p = not possible because lamination adds heat history

Inspection of the films and laminated plaques indicates that none of the samples, either in pure film or laminated constructions, turned hazy after heating. Summarizing Examples 1 and 2, benzoxazinones in polyesters form haze at specific concentrations and heating conditions described above whereas benzotriazines, benzotriazoles, and benzophenones do not show any visually-detectable levels of haze.

### Example 3

Some of the films generated in Examples 1 and 2 were subjected to Xenon-Arc artificial weathering according to ASTM G155 Cycle 1 protocol. The change in haze was recorded at 300-hour intervals. The results are shown in Table 3 below.

TABLE 3
Xenon-Arc Weathering: The Change in % Haze Readings At 300 Hour Intervals

| | | 0 | 300 | 600 | 900 | 1200 | 1500 | 1800 | 2100 | 2400 |
|---|---|---|---|---|---|---|---|---|---|---|
| | | Hours | Hours | Hours | Hours | Hours | Hours | Hours | Hours | Hours |
| | Initial % Haze | of | of | of | of | of | of | of | of | of |
| Material | Measurement | Exposure | Exposure | Exposure | Exposure | Exposure | Exposure | Exposure | Exposure | Exposure |
| 6.0% Cyasorb 1164 | 1.1 | 0 | 0.03 | 0.02 | −0.03 | 0.72 | 2.74 | 4.34 | 9.43 | 16.94 |
| 6.0% Cyasorb 3638 | 1.92 | 0 | −0.35 | −0.6 | 0.06 | 3.4 | 12.15 | 19.5 | 29.1 | 46.1 |
| 6.0% Tinuvin 234 | 0.42 | 0 | 0.32 | 0.73 | 2.33 | 9.7 | 36.12 | 38.24 | 57.03 | 69.93 |
| 6.0% Tinuvin 327 | 0.23 | 0 | 0.14 | 0.33 | 0.83 | 2.97 | 6.58 | 12.53 | 18.09 | 29.61 |
| 6.0% Tinuvin P | 1.05 | 0 | 0.2 | 0.3 | 0.42 | 1.53 | 6.85 | 14.09 | 21.18 | 30.05 |
| Spectar control (no UV) | 0.65 | 0 | −0.09 | 0.62 | 4.07 | 11.1 | 28.34 | 52.75 | no reading | no reading |

The results in Table 3 indicate that benzotriazine UV absorbers in a Spectar™ copolyester base provide optimal weathering performance versus the other classes of absorbers. That is, the benzotriazine UV absorber sample developed the least amount of haze over time.

### Example 4

This example describes how to manufacture a clear, decorative laminate intended for outdoor use.

A layup was constructed according to the following layered arrangement (from the bottom, upward): (1) one piece of 60-mil rubber silicone pad for pressure distribution; (2) 30-mil polished metal plate; (3) “Ultracast patent” release paper (available from Sappi-Warren); (4) ˜3 mil-thick clear extruded copolyester film containing 6% Cyasorb 1164 with a surface roughness (Ra) value of about 90 microinches oriented upward (matte texture toward the sheet to be described next) to prevent air entrapment; (5) 118-mil Spectar™ copolyester plastic sheeting with matte surface upward; (6) randomly distributed fossil leaves (the decorative inclusion); and repeating the layers (1)-(5) in reverse.

The layup was transferred to a heated press with top and bottom plate temperature set points of 120° C. A metal transfer plate was also used beneath the layup to help properly position the structure in the press. The press was closed around the structure using a setting of roughly 15,000 foot-pounds (roughly 100 psig on the article). After approximately eight minutes (when the interfacial sheet-to-sheet temperature reached about 230° F.), the heat to the plates was turned off and the cooling water turned on. When the interfacial sheet temperature reached 130° F., the layup was removed from the press for inspection. No haze was present from this heat history.

### Example 5

### Prophetic

Repeat the layup in Example 4, then place the “book” into a vacuum-bag and evacuate to 50 mm Hg. Instead of using heated platens to achieve thermal bonding, place the layup into a convection oven or autoclave to achieve a similar effect.

### Example 6

The edges of the clear, decorative laminate made in Example 4 were trimmed to form an aesthetically-pleasing part. The cut edges were flame-polished with a butane micro-torch until the edges became glossy or glass-like. Even with this additional heat history, the edges of the laminate remained visually clear.

### Example 7

A clear 155-mil sheet of Spectar™ copolyester with 6% Cyasorb 1164 concentrated in the upper 3 mils was heated to 290° F. in a thermoforming oven (took about 6 minutes). The sagging sheet was brought out of the oven and forced over a skylight mold. The sheet was cooled for about 4 minutes under forced-air circulation until cool. Even with this additional heat history, the surface of the sheet remained visually clear.

### Example 8

### Comparative

A wooden table was coated with a layer of Spectar™ plastic sheeting and a co-extruded layer of Spectar™ copolyester with 2.6% Cyasorb 3638 on the exterior. Since a hardcoat layer had not been applied to the tabletop surface, these layers became scratched over time to the extent that the table was no longer aesthetically pleasing.

A heat gun was used to remove the scratches. Although the scratches were removed, the tabletop turned hazy, partially masking the wood surface beneath.

The use of Spectar™ copolyester with 2.6% Cyasorb 1164 in the co-extruded surface layer would have prevented this cosmetic defect.

### Example 9

### Prophetic

A clear medical device is manufactured from copolyesters that will experience intense short wavelength (including UV) rays. Thus, it is provided UV protection via 3.0 wt % of Cyasorb 1164. This clear part undergoes sterilization at 121° C. for 15 minutes and remains clear.

Note the use of Cyasorb 3638 at this loading level would have caused hazing in an otherwise clear part.

The invention has been described in detail with particular reference to preferred embodiments thereof, but it will be understood that variations and modifications can be effected within the spirit and scope of the invention.

We claim:

1. A laminated article obtained by applying heat and pressure to two or more layers, wherein at least one of said layers comprises a benzotriazine UV absorber and a polymer selected from a transparent copolyester and a miscible polyester/polycarbonate blend.

2. The article according to claim 1, wherein said benzotriazine UV absorber is 2-[4,6-bis(2,4-dimethylphenyl)-1,3,5-triazin-2-yl]-5-(octyloxy)phenol or 2-(4,6-diphenyl-1,3,5-triazin-2-yl)-5-hexyloxy-phenol.

3. The article according to claim 1, wherein said benzotriazine UV absorber is 2-[4,6-bis(2,4-dimethylphenyl)-1,3,5-triazin-2-yl]-5-(octyloxy)phenol.

4. The article according to claim 1, wherein said copolyester comprises:
(a) a diacid component comprising at least 80 mole % of terephthalic acid residues; and
(b) a diol component comprising from 30 to 88 mole % of ethylene glycol residues and from 12 to 70 mole % of 1,4-cyclohexanedimethanol residues or neopentyl glycol residues or both, based on 100 mole % of diacid residues and 100 mole % of diol residues.

5. The article according to claim 4, wherein said copolyester further comprises residues of a branching agent.

6. The article according to claim 5, wherein said branching agent is selected from trimesic acid, trimellitic acid, pyromellitic acid, citric acid, tartaric acid, trimellitic anhydride, pyromellitic dianhydride, trimethylolpropane, glycerol, pentaerythritol, 3-hydroxyglutaric acid, dendritic polymers, glycidyl methacrylate, and mixtures thereof.

7. The article according to claim 1, wherein said polyester/polycarbonate blend comprises:
(a) 1 to 99 weight % of a polyester, comprising:
(i) a diacid component comprising the residues of aliphatic, alicyclic, and/or aromatic dicarboxylic acids, wherein the aromatic portion of said aromatic dicarboxylic acid has 6-20 carbon atoms and wherein the aliphatic or alicyclic portion of said aliphatic or alicyclic dicarboxylic acid has 3-20 carbon atoms; and
(ii) a diol component comprising from 40 mole % to 100 mole % of 1,4-cyclohexanedimethanol residues and, optionally, the residues of at least one additional aliphatic glycol having 2-20 carbon atoms;
wherein the total mole percentages for the diol component equals 100 mole %; and
(b) 1 to 99 weight % of a polycarbonate,
wherein the total combined weight percentage of polyester and polycarbonate in the polyester/polycarbonate blend equals 100 weight %.

8. The article according to claim 7, wherein the polyester in the polyester/polycarbonate blend further comprises residues of a branching agent selected from trimesic acid, trimellitic acid, pyromellitic acid, citric acid, tartaric acid, trimellitic anhydride, pyromellitic dianhydride, trimethylolpropane, glycerol, pentaerythritol, 3-hydroxyglutaric acid, dendritic polymers, glycidyl methacrylate, and mixtures thereof.

9. The article according to claim 1, which further comprises an inclusion between said two or more layers selected from fabric; metallic wire, rod, or bar; stone; paper; colored film; decorative film; light modifying film; printed image; vegetation; wood; wood chip; bamboo; pine straw; moss; lichen; grass; thatch; flower; flower petal; wheat; grains; beads; pellets; glass; crushed glass; pebbles; an electrically energized device selected from light emitting capacitors, light emitting diodes, and printed circuit boards; paper that emit light when energized; electrochromic layer; photovoltaic; transmitter; receiver; antenna; electromagnet; electrode; a smart sensor capable of detecting wind speed and direction, temperature, pressure, relative humidity, rainfall, motion, radiation, or a specific chemical species; and combinations thereof.

10. The article according to claim 1, which comprises a decorative texture or design on a surface thereof.

11. A process for making a laminated article, which comprises applying heat and pressure to two or more layers, wherein at least one of said layers comprises a benzotriazine UV absorber and a polymer selected from a transparent copolyester and a miscible polyester/polycarbonate blend.

12. The process according to claim 11, wherein said benzotriazine UV absorber is 2-[4,6-bis(2,4-dimethylphenyl)-1,3,5-triazin-2-yl]-5-(octyloxy)phenol or 2-(4,6-diphenyl-1,3,5-triazin-2-yl)-5-hexyloxy-phenol.

13. The process according to claim 11, wherein said benzotriazine UV absorber is 2-[4,6-bis(2,4-dimethylphenyl)-1,3,5-triazin-2-yl]-5-(octyloxy)phenol.

14. The process according to claim 11, wherein said copolyester comprises:
(a) a diacid component comprising at least 80 mole % of terephthalic acid residues; and
(b) a diol component comprising from 30 to 88 mole % of ethylene glycol residues and from 12 to 70 mole % of 1,4-cyclohexanedimethanol residues or neopentyl glycol residues or both, based on 100 mole % of diacid residues and 100 mole % of diol residues.

15. The process according to claim 14, wherein said copolyester further comprises residues of a branching agent.

16. The process according to claim 15, wherein said branching agent is selected from trimesic acid, trimellitic acid, pyromellitic acid, citric acid, tartaric acid, trimellitic anhydride, pyromellitic dianhydride, trimethylolpropane, glycerol, pentaerythritol, 3-hydroxyglutaric acid, dendritic polymers, glycidyl methacrylate, and mixtures thereof.

17. The process according to claim 11, wherein said polyester/polycarbonate blend comprises:
(a) 1 to 99 weight % of a polyester, comprising:
(i) a diacid component comprising the residues of aliphatic, alicyclic, and/or aromatic dicarboxylic acids, wherein the aromatic portion of said aromatic dicarboxylic acid has 6-20 carbon atoms and wherein the aliphatic or alicyclic portion of said aliphatic or alicyclic dicarboxylic acid has 3-20 carbon atoms; and
(ii) a diol component comprising from 40 mole % to 100 mole % of 1,4-cyclohexanedimethanol residues and, optionally, the residues of at least one additional aliphatic glycol having 2-20 carbon atoms;
wherein the total mole percentages for the diol component equals 100 mole %; and
(b) 1 to 99 weight % of a polycarbonate,
wherein the total combined weight percentage of polyester and polycarbonate in the polyester/polycarbonate blend equals 100 weight %.

18. The process according to claim 17, wherein the polyester in the polyester/polycarbonate blend further comprises residues of a branching agent selected from trimesic acid, trimellitic acid, pyromellitic acid, citric acid, tartaric acid, trimellitic anhydride, pyromellitic dianhydride, trimethylolpropane, glycerol, pentaerythritol, 3-hydroxyglutaric acid, dendritic polymers, glycidyl methacrylate, and mixtures thereof.

19. The process according to claim 11, wherein said laminated article further comprises an inclusion between said two or more layers selected from fabric; metallic wire, rod, or bar; stone; paper; colored film; decorative film; light modifying film; printed image; vegetation; wood; wood chip; bamboo; pine straw; moss; lichen; grass; thatch; flower; flower petal; wheat; grains; beads; pellets; glass; crushed glass; pebbles; an electrically energized device selected from light emitting capacitors, light emitting diodes, and printed circuit boards; paper that emit light when energized; electrochromic layer; photovoltaic; transmitter; receiver; antenna; electromagnet; electrode; smart sensor capable of detecting wind speed and direction, temperature, pressure, relative humidity, rainfall, motion, radiation, or a specific chemical species; and combinations thereof.

20. The process according to claim 11, wherein said laminated article comprises a decorative texture or design on a surface thereof.

21. A method for preventing or inhibiting haze from developing in a UV absorber-containing laminated article during application of heat and pressure, said method comprising using 2-[4,6-bis(2,4-dimethylphenyl)-1,3,5-triazin-2-yl]-5-(octyloxy)phenol or 2-(4,6-diphenyl-1,3,5-triazin-2-yl)-5-hexyloxy-phenol as the UV absorber.

22. The method according to claim 21, wherein the UV absorber is 2-[4,6-bis(2,4-dimethylphenyl)-1,3,5-triazin-2-yl]-5-(octyloxy)phenol.
